(19) United States
(12) Patent Application Publication
(10) Pub. No.: US 2010/0246464 A1
(43) Pub. Date: Sep. 30, 2010

(54) POWER CONSERVATION THROUGH BI-DIRECTIONAL ASSOCIATION OF MULTIPLE DEVICES

(75) Inventors: Yanjun SUN, Richardson, TX (US); Ariton E. XHAFA, Plano, TX (US); Shantanu KANGUDE, Dallas, TX (US); Xiaolin LU, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/729,963

(22) Filed: Mar. 23, 2010

Related U.S. Application Data
(60) Provisional application No. 61/162,386, filed on Mar. 23, 2009.

(51) Int. Cl. G08C 17/00

(52) U.S. Cl. 370/311

(57) ABSTRACT

A system comprises radio circuitry, an access point (AP) feature, and a station (STA) feature. The AP feature causes the radio circuitry to transmit data to a hardware device during a beacon interval. The AP feature is not used to receive data from the hardware device during the beacon interval except to receive data request signals. The STA feature causes the radio circuitry to receive data from the hardware device during the beacon interval. The STA feature is not used to transmit data to the hardware device during the beacon interval except to transmit data request signals. The radio circuitry is in a de-powered state during the beacon interval when the radio circuitry does not transmit or receive data or data request signals.

### CROSS-REFERENCE TO RELATED APPLICATION

The present application claims priority to U.S. Provisional Patent Application No. 61/162,386, filed on Mar. 23, 2009 (Attorney Docket No. TI-67880), which is hereby incorporated herein by reference.

### BACKGROUND

Wireless networks (e.g., wireless local area networks (WLANs)) enable multiple devices to communicate with each other. Such networks often are hierarchical in that one device serves as an access point (AP) and other devices serve as stations (STAB). Generally, the AP synchronizes the network and provides various types of functionality to the STAB. Typically, the AP has access to a constant power supply (e.g., an alternating current (AC) power supply from a wall-mounted power jack coupled to a power grid) and, therefore, is nearly always in an “on” state.

In some cases, a battery-operated wireless device may serve as the AP for a wireless network. In such cases, the AP's battery power is finite. To avoid frequent recharging, the AP's battery life must be conserved. Even if a device is partially or fully powered by way of a power grid, power conservation still is desirable.

### SUMMARY

The problems noted above are solved in large part by a system that comprises radio circuitry, an access point (AP) feature, and a station (STA) feature. The AP feature causes the radio circuitry to transmit data to a hardware device during a beacon interval. The AP feature is not used to receive data from the hardware device during the beacon interval except to receive data request signals. The STA feature causes the radio circuitry to receive data from the hardware device during the beacon interval. The STA feature is not used to transmit data to the hardware device during the beacon interval except to transmit data request signals. The radio circuitry is in a de-powered state during the beacon interval when the radio circuitry does not transmit or receive data or data request signals.

The problems noted above also are solved in large part by a method that comprises powering radio circuitry of a hardware device. The method also comprises, during a beacon interval, transmitting data to another hardware device using the radio circuitry and an access point (AP) feature of the hardware device, but not receiving data using the AP feature except for data request signals. The method further comprises, during the beacon interval, receiving data from the another hardware device using the radio circuitry and a station (STA) feature of the hardware device, but not transmitting data using the STA feature except for data request signals. The method still further comprises de-powering the radio circuitry during the beacon interval when not transmitting or receiving data or data request signals using the radio circuitry.

The problems noted above also are solved in large part by a method that comprises powering radio circuitry of a first device and radio circuitry of a second device. The method also comprises transmitting a beacon signal from an access point (AP) feature of the first device to a station (STA) feature of the second device, thus initiating a beacon interval. If the beacon signal indicates that the first device has data to send to the second device, the method comprises the STA feature of the second device responding to the beacon signal by transmitting a data request signal to the AP feature of the first device and, in response to the data request signal, the AP feature of the first device transmitting the data to the STA feature of the second device, where the STA feature of the first device is not transmitting data. The method further comprises. during the beacon interval, de-powering the radio circuitry of the first device.

### BRIEF DESCRIPTION OF THE DRAWINGS

For a detailed description of exemplary embodiments of the invention, reference will now be made to the accompanying drawings in which:

FIG. 1 shows a block diagram of an illustrative system in accordance with various embodiments;

FIG. 2 shows a block diagram of an illustrative device of the system of FIG. 1 in accordance with various embodiments;

FIG. 3 shows a block diagram of an illustrative interaction between the devices of the system of FIG. 1, in accordance with various embodiments; and

FIG. 4 shows a flow diagram of an illustrative method in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct electrical connection. Thus, if a first device couples to a second device, that connection may be through a direct electrical connection, or through an indirect electrical connection via other devices and connections. The term “bi-directional association” refers to the general technique described herein.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein is a technique whereby radio circuitry in wireless communication devices belonging to a wireless network can frequently be de-powered without losing data packets addressed to those devices. More specifically, each of multiple wireless devices in the network comprises an access point (AP) feature and a station (STA) feature. Such features may comprise hardware, software, firmware, or any combination thereof. Wireless transmissions from a wireless device in the network are performed solely using the AP feature and not using the STA feature, except when the STA feature sends data request signal(s) to other network devices. Similarly, wireless receptions by a wireless device in the network are performed solely using the STA feature and not using the AP feature, except when the AP feature receives data request signal(s) from other network devices. At all or nearly all other times, the radio circuitry is de-powered, thereby conserving power. Although the radio circuitry of a wireless device may be de-powered, data packets addressed to that wireless device are not lost, as explained below.

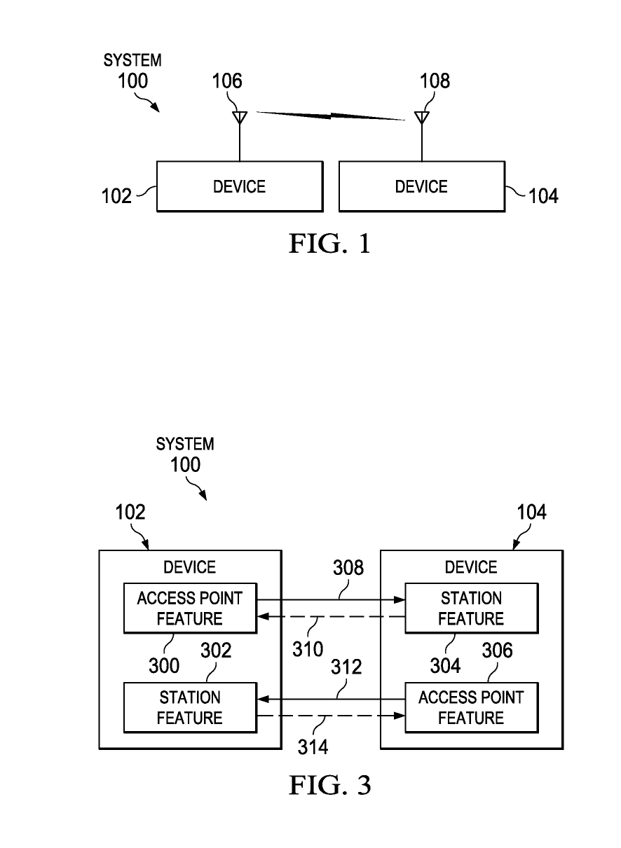

FIG. 1 shows a block diagram of an illustrative system 100 in accordance with various embodiments. The system 100 comprises multiple devices, such as devices 102 and 104. In some embodiments, the devices 102 and/or 104 are at least partially battery-powered, while in some embodiments, the devices 102 and/or 104 at least partially powered by way of a power grid (e.g., via a power jack). Device 102 uses antenna 106 to communicate with antenna 108 of device 104. The devices 102 and 104 may, for instance, comprise cell phones, personal digital assistants, smart phones, printers, computers, or any other suitable type of device. The system 100 may comprise more devices than the two devices shown in FIG. 1. The devices 102 and 104 communicate with each other using any suitable protocol, such as an 802.11 protocol. All 802.11 protocols are hereby incorporated herein by reference.

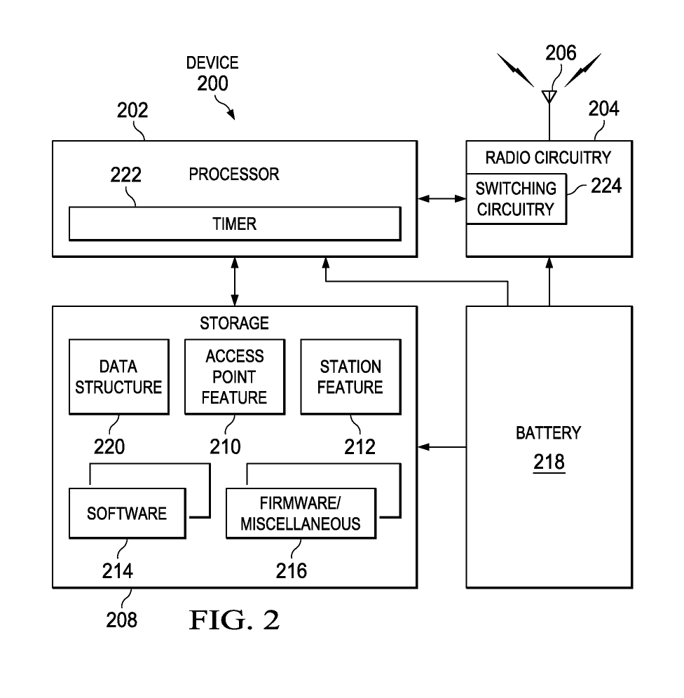

FIG. 2 shows a block diagram of an illustrative device 200 in accordance with various embodiments. The device 200 is a generic representation of one or more of the devices 102 and 104 in the system 100 of FIG. 1. The device 200 comprises a processor 202 coupled to radio circuitry 204 (e.g., one or more transceivers) and storage 208. The processor 202 comprises a timer 222. The radio circuitry 204 wirelessly communicates with other devices by way of the antenna 206. In some embodiments, the radio circuitry 204 comprises some or all circuit logic that must be powered in order to transmit or receive data by way of the antenna 206. The processor 202 may power or de-power (i.e., “activate” or “deactivate;” “awaken” or “put to sleep”) the radio circuitry 204 using switching circuitry 224.

The storage 208 may comprise any suitable form of storage (e.g., a hard drive, flash drive, etc.). The storage 208 comprises various types of processor-executable code, including an access point (AP) feature 210, a station (STA) feature 212, software 214 and firmware/miscellaneous executable code 216. When any of these features is described herein as performing an action, it is to be understood that execution of that feature is causing the processor 202 to perform that action. In some embodiments, however, one or more features may comprise hardware circuitry or a combination of hardware and software; in such cases, when a feature is described herein as performing an action, it is to be understood that the feature is performing that action on its own or at least partially on its own. Further, as explained above, the radio circuitry 204 may comprise one or more transceivers; if the circuitry 204 comprises multiple transceivers, then, in at least some embodiments, each of the AP feature 210 and the STA feature 212 may use or otherwise associate with a dedicated transceiver.

In some embodiments, one or more of the processor 202, radio circuitry 204 and the storage 208 couple to a battery 218. The battery 218 may be any suitable type of battery, including rechargeable and non-rechargeable batteries. Life of the battery 218 is affected by the period of time for which the radio circuitry 204 is powered. The longer the radio circuitry 204 is powered, the more quickly the battery 218 is drained and must be replaced or recharged. In some embodiments, the device 200 may draw power from a power grid (e.g., via a power jack) exclusively or in combination with the battery 218; even in such embodiments, power conservation is desirable.

In at least some embodiments, the AP feature 210 comprises a virtual access point. The term “virtual access point” refers to a simulation, emulation or other similar functional representation of a hardware access point, whereby the virtual access point comprises one or more functional components that are not constrained by the physical boundaries that define one or more real or physical access points. The functional components may comprise one or more of the following: real or physical devices, interconnect buses and networks, and/or software or firmware programs executing on one or more processors. In some embodiments, a virtual access point may, for example, comprise a subset of functional components that include some but not all functional components within a real or physical access point, may comprise some functional components of multiple real or physical access points, may comprise all the functional components of one real or physical access point, but only some components of another real or physical access point, or may comprise all the functional components of multiple real or physical access points. Many other hardware and/or software and/or firmware combinations are possible, and all such combinations are included within the scope of the present disclosure.

In at least some embodiments, the STA feature 212 comprises a virtual station. The term “virtual station” refers to a simulation, emulation or other similar functional representation of a hardware station, whereby the virtual station comprises one or more functional components that are not constrained by the physical boundaries that define one or more real or physical stations. The functional components may comprise one or more of the following: real or physical devices, interconnect buses and networks, and/or software or firmware programs executing on one or more processors. In some embodiments, a virtual station may, for example, comprise a subset of functional components that include some but not all functional components within a real or physical station, may comprise some functional components of multiple real or physical stations, may comprise all the functional components of one real or physical stations, but only some components of another real or physical station, or may comprise all the functional components of multiple real or physical stations. Many other hardware and/or software and/or firmware combinations are possible, and all such combinations are included within the scope of the present disclosure.

The storage 208 may additionally comprise a data structure 220. The data structure 220, in at least some embodiments, comprises a routing table that instructs the processor 202 on how to route data through the device 200. For instance, data that is to be transmitted by the radio circuitry 204 may be addressed by the processor 202 in accordance with information stored in the data structure 220.

FIG. 3 shows a block diagram representing an illustrative interaction between the AP features and STA features of the devices 102 and 104. More specifically, FIG. 3 shows the system 100 of FIG. 1 comprising devices 102 and 104. As previously explained, the system 100 may comprise additional devices, as desired. Such additional devices may be similar to the devices 102 and 104 and the device 200 of FIG. 2. The devices 102 and 104 shown in FIG. 3 each comprise virtual APs and STAB. In particular, the device 102 comprises an AP feature 300 and an STA feature 302, each of which is virtual. Further, the device 104 comprises an AP feature 304 and an STA feature 306, each of which is virtual. Wireless communications from the AP feature 300 to the STA feature 304 are represented by the arrow 308. Wireless communications from the STA feature 304 to the AP feature 300 are represented by the arrow 310. Arrow 312 represents wireless communications from the AP feature 306 to the STA feature 302. Arrow 314 represents wireless communications from the STA feature 302 to the AP feature 306. At least some of the data transfers indicated by arrows 308, 310, 312 and 314 may result from routing data stored in the data structure 220 of FIG. 2. Although FIGS. 2 and 3 show the AP features and STA features as being distinct entities, in some embodiments, they may be part of a single entity (e.g., part of common software; part of a combination of hardware and/or software and/or firmware, etc.).

In at least some embodiments, all data that is to be transmitted by the device 102 is transmitted using the AP feature 300. In some such embodiments, the STA feature 302 is not used to transmit data from the device 102, except in the case that the STA feature 302 sends a data request signal (e.g., a PSPoll signal) in response to a beacon from another device indicating that it has data ready to send to the device 102. In that case, the STA feature 302 may transmit a data request signal in response to the beacon signal, thereby causing the STA feature 302 to receive the data requested.

In at least some embodiments, all data that is to be received by the device 102 is received using the STA feature 302. In some such embodiments, the AP feature 300 does not receive any data for the device 102, except in the case that the AP feature 300 receives a data request signal (e.g., a PSPoll signal) from the device 104. In such cases, the AP feature 300 may respond to the data request signal by transmitting data to the device 104.

In at least some embodiments, all data that is to be transmitted by the device 104 is transmitted using the AP feature 306. In some such embodiments, the STA feature 304 is not used to transmit data from the device 104, except in the case that the STA feature 304 sends a data request signal (e.g., a PSPoll signal) in response to a beacon from another device indicating that it has data ready to send to the device 102. In that case, the STA feature 304 may transmit a data request signal in response to the beacon signal, thereby causing the STA feature 304 to receive the data requested.

In at least some embodiments, all data that is to be received by the device 104 is received using the STA feature 304. In some such embodiments, the AP feature 306 does not receive any data for the device 104, except in the case that the AP feature 306 receives a data request signal (e.g. a PSPoll signal) from the device 102. In such cases, the AP feature 306 may respond to the data request signal by transmitting data to the device 102.

The foregoing transmission scheme ensures that at virtually any particular device in the system 100, the AP feature will perform nearly all data transmissions (except for data request signals that are transmitted using the STA feature) and the STA feature will perform nearly all data reception (except for receipt of data request signals from other devices, which are received using the AP feature). This scheme ensures that no data is sent without first being heralded by a beacon signal and a data request signal. All data that is transmitted by an AP feature is transmitted only after a beacon signal is transmitted and a data request signal is received. Because all such data transmissions are preceded by a beacon signal and a data request signal, and because beacon signals are separated by regular beacon intervals, the present scheme enables radio circuitry (used for data transmission and reception) to be de-powered without the risk of missing data that would otherwise have been received had the radio circuitry been powered.

For instance, referring to FIGS. 2-3, assume that the radio circuitry 204 for both devices 102 and 104 is de-powered (or “asleep”). Further assume that a beacon interval for the device 102 is to expire soon (beacon interval expiry may be tracked using, e.g., timer 222). Accordingly, the processor 202 may power the radio circuitry 204 so that the radio circuitry 204 is “awake” (e.g., using switching circuitry 224). After the beacon interval expires, the AP feature 300 may transmit a beacon signal to the STA feature 304. The beacon signal indicates, among other things, that the device 102 has no data for the device 104. The device 104, knowing that the device 102 beacon interval was to expire, also powered its radio circuitry in anticipation of receiving the beacon signal from the AP feature 300. The STA feature 304 receives the beacon signal from the AP feature 300 as indicated by arrow 308. The STA feature 304, upon determining that the device 102 has no data for the device 104, de-powers its radio circuitry, thereby conserving power in the battery 218. Similarly, the AP feature 300 (or some other suitable part of the device 102), upon determining that the device 102 has no data for the device 104, de-powers its radio circuitry, thereby conserving power in its battery 218.

Some time later, the device 104's beacon interval may be approaching expiry. In such a case, the device 104's radio circuitry is powered so that it is “awake” and the device 102's radio circuitry is similarly powered. Upon expiry of the beacon interval, the AP feature 306 transmits a beacon signal to the STA feature 302, as indicated by the arrow 312. This time, the device 104 has data to transmit to the device 102, and the AP feature 306 transmits a beacon signal indicating this fact. Because the device 104 is “aware” that the device 102 will request the data upon receiving the beacon signal, the device 104 keeps its radio circuitry in a powered state so that it can receive the data request and respond accordingly.

In response to receiving such a beacon signal, the STA feature 302 sends a data request signal (e.g., a PSPoll signal in accordance with 802.11 protocols) to the AP feature 306, as indicated by the arrow 314. As previously explained, in some embodiments, the STA features do not transmit data except for such data request signals and the AP features do not receive data except for such data request signals. In response to receiving the data request signal from the STA feature 302, the AP feature 306 transmits the data to the STA feature 302, as indicated by arrow 312. After the data transmission is complete, both devices 102 and 104 de-power their radio circuitries, thereby conserving power, until a beacon interval for either device is about to expire, whereupon the devices' radio circuitries will be powered to enable communications between the two devices. While the devices' radio circuitries are de-powered, no data is sent, thereby mitigating concerns about data that might hypothetically be missed due to inactivation of radio circuitry. Not only are radio circuitries de-powered, but even if one device's radio circuitry was active/powered, that device would only transmit data using its AP feature—not its STA feature. Because that device would transmit data only using its AP feature, it would first send a beacon signal and would wait for a data request signal from the device to which the beacon signal was sent. Because the other device's radio circuitry would be de-powered, it would not send such a data request signal, and so that device sending the beacon signal would hold the data until a future time at which the data can be sent. Thus, this technique mitigates missed-data concerns in this additional way. Although the technique is described with reference to only two devices for simplicity and clarity, the technique may be used with any suitable number of devices.

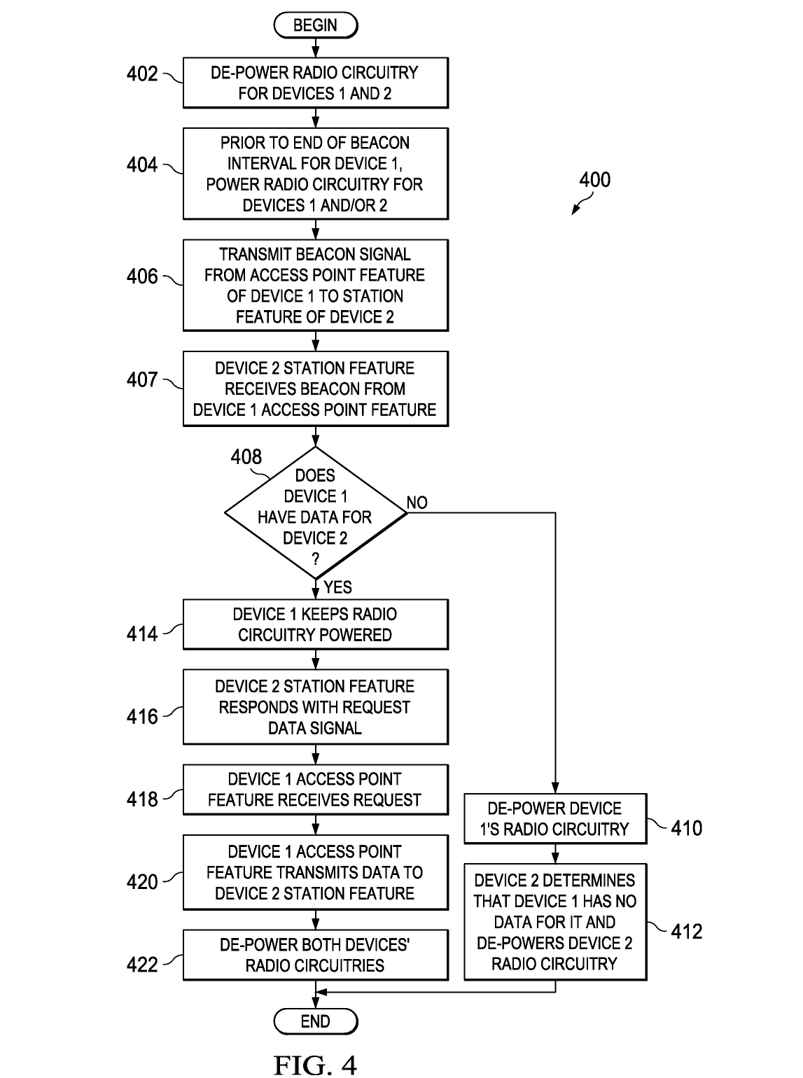

FIG. 4 shows a flow diagram of a method 400 in accordance with some embodiments. The method 400 is described with respect to illustrative devices 1 and 2, which are similar to devices 102 and 104. The method 400 comprises de-powering radio circuitry for devices 1 and 2 (block 402). The method 400 then comprises, prior to the end of a beacon interval for device 1, powering radio circuitry for devices 1 and/or 2 (block 404). The method 400 also comprises transmitting a beacon signal from the AP feature of device 1 to the STA feature of device 2 (block 406). The method 400 further comprises the device 2 STA feature receiving the beacon from the device 1 AP feature (block 407). The method 400 further comprises determining at the device 1 whether the beacon signal indicates that the device 1 has data to send to the device 2 (block 408). If device 1 has no data to send to device 2, the method 400 comprises de-powering the device 1's radio circuitry (block 410). After block 410, the method 400 comprises device 2 determining that device 1 has no data to send to device 2 and, thus, the device 2 de-powering its radio circuitry (block 412).

However, if, at block 408, the device 1 determines that it has data for device 2, the method 400 comprises the device 1 keeping its radio circuitry powered (block 414). Upon determining that device 1 has data to send to device 2, the device 2 STA feature sends a data request signal to the device 1 AP feature (block 416). The method 400 comprises the device 1 AP feature receiving the data request signal from the device 2 STA feature (block 418) and transmitting the requested data to the device 2 STA feature in response (block 420). Some or all of steps 416, 418 and 420 may be repeated as desired until some or all of the data that is ready for transmission is transmitted. After the data transmission is complete, the method 400 comprises both devices deactivating, or de-powering, their radio circuitries (block 422). As previously explained, in at least some embodiments of the method 400, neither device's STA feature transmits data to another device unless the transmission is a data request. Similarly, in at least some embodiments of the method 400, neither device's AP feature receives data from another device unless the reception comprises a data request. As suggested above, a similar process may be performed for device 2. The method 400 may be modified by rearranging its steps or by adding or deleting steps, as desired.

Further, in some embodiments, beacon signals of various devices may be synchronized so that they are sent within a predetermined amount of time. By sending most or all beacon signals within a predetermined amount of time, the various activities described above and in FIG. 4 in particular may occur within a short time frame, thus permitting radio circuitries to be de-powered for as long as possible and conserving as much battery life as possible. For instance, in some embodiments, a third device (not explicitly shown) may be added to system 100, and beacon signals sent by device 104 and the third device to the device 102 may be synchronized to be sent within a short time frame.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
radio circuitry;
an access point (AP) feature; and
a station (STA) feature;
wherein the AP feature causes the radio circuitry to transmit data to a hardware device during a beacon interval, and the AP feature is not used to receive data from the hardware device during the beacon interval except to receive data request signals;
wherein the STA feature causes the radio circuitry to receive data from the hardware device during the beacon interval, the STA feature is not used to transmit data to the hardware device during the beacon interval except to transmit data request signals;
wherein the radio circuitry is in a de-powered state during said beacon interval when the radio circuitry does not transmit or receive data or data request signals.

2. The system of claim 1, wherein the system comprises a battery-operated communication device.

3. The system of claim 1, wherein the AP feature and the STA feature comprise virtual devices.

4. The system of claim 1, wherein the radio circuitry exits said de-powered state and enters a powered state when the radio circuitry is to transmit or receive a beacon signal.

5. The system of claim 1, wherein the system comprises a data structure that indicates that all data to be transmitted by the system is to be transmitted using said AP feature.

6. A method, comprising:
powering radio circuitry of a hardware device;
during a beacon interval, transmitting data to another hardware device using the radio circuitry and an access point (AP) feature of the hardware device, but not receiving data using the AP feature except for data request signals;
during said beacon interval, receiving data from the another hardware device using the radio circuitry and a station (STA) feature of the hardware device, but not transmitting data using the STA feature except for data request signals; and
de-powering said radio circuitry during the beacon interval when not transmitting or receiving data or data request signals using the radio circuitry.

7. The method of claim 6, wherein said hardware device includes a battery-powered device.

8. The method of claim 6, wherein said AP feature and STA feature comprise virtual devices.

9. The method of claim 6, further comprising powering the radio circuitry prior to expiry of said beacon interval.

10. The method of claim 6, wherein not transmitting data using the STA feature except for data request signals comprises using a data structure that indicates that data to be transmitted by the radio circuitry is to be transmitted using the AP feature.

11. The method of claim 6, further comprising synchronizing a first beacon signal of a first device with a second beacon signal of a second device such that the STA feature receives said first and second beacon signals within a predetermined window of time.

12. A method, comprising:
powering radio circuitry of a first device and radio circuitry of a second device;
transmitting a beacon signal from an access point (AP) feature of the first device to a station (STA) feature of the second device, thus initiating a beacon interval;
if said beacon signal indicates that the first device has data to send to the second device:
the STA feature of the second device responding to said beacon signal by transmitting a data request signal to the AP feature of the first device; and
in response to said data request signal, the AP feature of the first device transmitting said data to the STA feature of the second device, the STA feature of the first device not transmitting data; and
during said beacon interval, de-powering the radio circuitry of the first device.

13. The method of claim 12, wherein said first and second devices comprise battery-powered devices.

14. The method of claim 12, wherein the STA feature of the first device not transmitting data comprises modifying a data structure stored in the first device to indicate that data that is to be transmitted by the first device is to be transmitted by said AP feature of the first device.

15. The method of claim 12, further comprising synchronizing a second beacon signal of the second device with a third beacon signal of a third device such that the STA feature of the first device receives said second and third beacon signals within a predetermined window of time.
